(19) United States
(12) Patent Application Publication
(10) Pub. No.: US 2015/0006340 A1
(43) Pub. Date: Jan. 1, 2015

(54) PAYMENT TRANSPARENCY TOOL

(71) Applicant: BANK OF AMERICA CORPORATION, Charlotte, NC (US)

(72) Inventors: Gregory Joseph Lloyd, Charlotte, NC (US); Melissa Christine Derville Hart, Cornelius, NC (US); Amy Marson Fistner, Charlotte, NC (US); Paula Christine Hanson, Worcester, MA (US); Joseph Neil Johansen, Rock Hill, SC (US); Traci Leigh Johnston Plyler, Denver, NC (US); Preston J. Taylor, Stallings, NC (US)

(21) Appl. No.: 13/932,713

(22) Filed: Jul. 1, 2013

(51) Int. Cl. G06Q 40/00

(52) U.S. Cl. CPC G06Q 40/12
USPC 705/30

(57) ABSTRACT

Embodiments of the invention comprise systems, computer program products, and methods for a payment transparency tool that enables users (e.g., employees and/or customers) to identify the rules for payment assessments, the reasons that specific payments were assessed on customer accounts, and the criteria for avoiding future payments. The payment transparency tool compiles and analyzes payment assessment data for various customer accounts, identifies customer account information for the accounts, and creates customized views for users to present clear explanations and data to address payment assessment questions. In some embodiments multiple payments assessed on multiple customer accounts may be presented to a user in an interface through a consolidated payment assessment list. Within an interface a user can view data related to the date a payment was assessed, the type of payment, the payment amount, payment rules, customer-specific reasons for the payment assessment, and avoidance rules.

### BACKGROUND

Transparency within an institution (e.g., financial institution) is increasingly important for employees or customers of the institution. The more transparency in the institution the easier it may be for employees or customers to understand the products and services offered by the institution.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer program products, and methods are described herein for a payment transparency tool that enables users (e.g., employees and/or customers) to identify the rules for payment assessments, the reasons that specific payments were assessed on customer accounts, and the criteria for avoiding future payments. The customer accounts may include, but are not limited to checking accounts, savings accounts, credit card accounts, investments accounts, retirement accounts, mortgage accounts, lines of credit, loan accounts, trading accounts, annuity accounts, or another other type of financial institution account. The free transparency tool provides users the ability to receive explanations for payment assessments, as well as specific customer account information related to why payments were assessed on specific customers or customer accounts. The payment transparency tool compiles and analyzes payment assessment data for various customer accounts, identifies customer account information for the accounts, and creates customized views for users to present clear explanations and data to address payment assessment questions. In some embodiments multiple payments assessed on multiple customer accounts may be presented to a user in an interface through a consolidated payment assessment list. Within an interface a user can view data related to the date a payment was assessed, the type of payment assessed, the payment amount assessed, payment rules, customer-specific reasons for the payment assessment (e.g., account below balance minimum, no direct deposit, or other like account rules), or other like information related to assessed payments. In some embodiments customers may be able to access the free transparency tool through customers' online banking account interfaces, or other like interfaces, over web browsers or mobile applications.

Embodiments of the invention relate to systems, computer program products, and methods comprising receiving an inquiry regarding a payment assessed to a customer account of a customer at a financial institution; accessing customer account information for the customer account of the customer; determining payment rule information for the customer account based on the customer account information; determining customized customer payment information that resulted in the payment; and providing the payment rule information and the customized customer payment information to a user.

In further accord with an embodiment of the invention, the user is an employee of the financial institution and the payment rule information and customized customer payment information is provided to the employee over an employee payment transparency interface.

In another embodiment of the invention, the user is the customer of the financial institution and the payment rule information and customized customer payment information is provided to the customer over a customer payment transparency interface, wherein the customer payment transparency interface is an online banking account interface.

In yet another embodiment, the invention further comprises determining avoidance rules that would avoid the payment assessed in the future; and providing the avoidance rules to the user.

In still other embodiments, the invention further comprises providing a consolidated payment assessment list in a centralized payment transparency interface, wherein the consolidated payment assessment list provides the payment rule information and the customized customer payment information to a user for two or more payments for two or more customer accounts.

In further accord with an embodiment, the invention comprises receiving a time period selection indicating a time period for the consolidated payment assessment list; and providing the payment rule information and the customized customer payment information in the consolidated payment assessment list for the two or more payments for two or more customer accounts to the user for the time period.

In yet another embodiment, the invention further comprises receiving a customer accounts selection indicating the two or more customer accounts to include in the consolidated payment assessment list; and providing the payment rule information and the customized customer payment information in the consolidated payment assessment list for the two or more customer accounts selected.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a high level process flow for a payment transparency method, in accordance with one embodiment of the invention;

FIG. 2 illustrates a block diagram for a payment transparency system environment, in accordance with an embodiment of the invention;

FIG. 3 illustrates an employee payment transparency method, in accordance with one embodiment of the invention;

FIG. 4 illustrates a customer payment transparency method, in accordance with one embodiment of the invention;

FIG. 5 illustrates an employee payment transparency interface, in accordance with an embodiment of the invention; and

FIG. 6 illustrates a customer payment transparency interface, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Thus, methods, systems, computer programs, and the like, are herein disclosed that provide for a payment transparency tool that allows both customers 4 and employees 6 to identify general payment rules, customized customer payment information for one or more of the customer accounts, and payment avoidance rules to the customers 4. The payment transparency tool assemblies the customer account information (e.g., information related to the payment assessment, account type, account balances, direct deposit information, customer type, customer status within the institution, or other like customer information or account information), determines payment rules, determine customized customer payment information that resulted in the assessed payments for the customer accounts, and provides the information to the customer 4 or employees 6 in a single consolidated payment assessment location for all of the customer's accounts. As such a customer 4 or an employee 6 may identify the reasons the payments were assessed, and actions the customer may take to avoid the assessment of payments in the future.

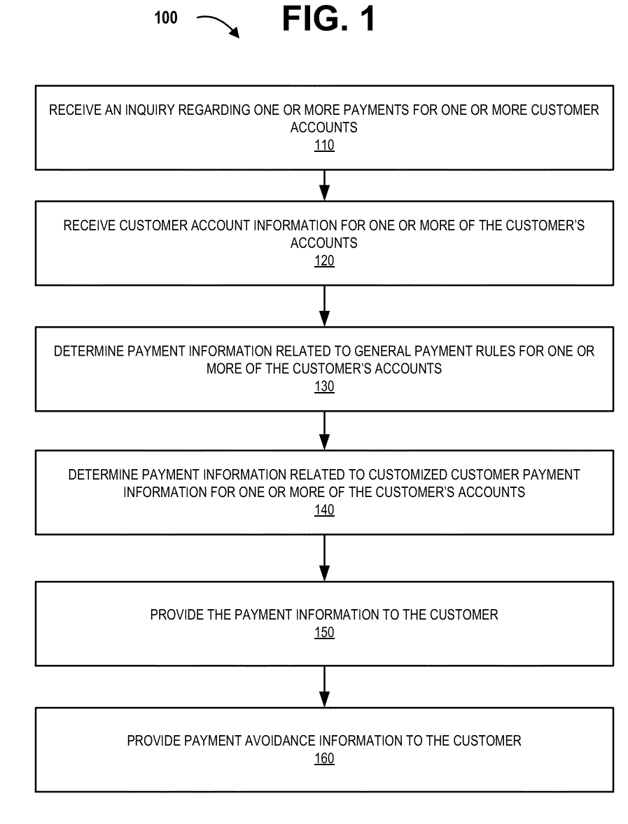

FIG. 1 illustrates a high level process flow for a payment transparency method 100 in accordance with one embodiment of the invention. As illustrated by block 110 in FIG. 1 the payment transparency tool receives an inquiry regarding a one or more payments for one or more customer accounts. The inquiry may be initiated by a customer 4, for example, through the use of an online banking account or other interface, or by an employee 6, for example, through a financial institution interface, as is discussed in further detail later.

As illustrated by block 120 in FIG. 1 the payment transparency tool receives customer account information for one or more of the customer's accounts. For example, the payment transparency tool may identify the customer based on input provided by the customer 4 or employee 6, and access customer account information for one or more of the customer's accounts. The customer account information may be the type of customer accounts, customer account balances (e.g., current balance, minimum balance, average balance, cumulative balances between accounts, or the like), direct deposits into the customer accounts, billing periods of the customer accounts, customer account transaction activity, customer payment assessments, customer status within the financial institution (e.g., retail customer, premium retail customer, or the like), or other like customer information related to the customer's accounts. The customer account information of a one or more customer accounts may be used in order to determine how and why payments were, or will be, assessed on a customer account.

Block 130 in FIG. 1 illustrates that the payment transparency tool determines payment information related to the general payment rules for one or more of the customer's accounts. The general payment rules may indicate the amount of the payment assessed and the reasons for the assessment for each of the customer's accounts. For example, the payment transparency tool may determine that for a particular checking account a payment may be assessed on the account if the average monthly balance is below a specified amount. In other examples, payments may be assessed on various accounts for a number of different reasons. The payments assessed for a particular account or the reasons for the assessment may be change over time, and thus, the payment transparency tool may access the current payment rules for each of the customer accounts as needed. In some embodiments the payment transparency tool may access different databases, or locations, where the information regarding the payment rules associated with customer accounts are stored. In other embodiments the payment rules for various customer accounts may be stored in a centralized location, such that the payment transparency tool accesses the various payment rules for multiple customer accounts in a single location.

As illustrated in block 140 in FIG. 1, the payment transparency tool determines payment information related to customized customer payment information for one or more of the customer's accounts. The customized customer payment information is specific information about a particular customer account or associated customer accounts that are used to determine why one or more payments were assessed on the customer's accounts. For example, the payment transparency tool may identify that for a customer's checking account the customer's average daily balance was below a particular amount and the customer does not have a direct deposit set up into the account. Furthermore, the payment transparency tool may identify that the balance in the customer's savings account is less than the threshold account. In this example, this customized customer payment information indicates why the customer was assessed a particular payment associated with the customer's checking account.

Block 150 in FIG. 1 illustrates that the payment transparency tool provides the payment information to the customer. For example, the payment transparency tool may provide a list of all of the payments assessed from one or more customer accounts for a period of time (e.g., one year, three months, one months, two weeks, or the like), as well as in some embodiments future payments that are going to be assessed on the customer's accounts unless action is taken by the customer 4. The payment information may be provided to the customer 4 or the employee 6 using interfaces, as will be discussed in further detail later.

As illustrated by block 160 in FIG. 1, the payment transparency tool provides payment avoidance information to the customer 4. As such, the payment avoidance information may include specific actions that the customer may take with respect to the one or more customer's accounts in order to prevent a payment from being assessed on one or more of the customer's accounts. For example, the payment transparency tool may notify the customer 4 or employee 6 that in order to avoid a payment assessment on a checking account the customer 4 may have to increase the average balance of the account to above a threshold level, make direct deposits of a minimum threshold amount to the account, or increase the balance of a savings account over a threshold level. The payment avoidance information is discussed below in further detail.

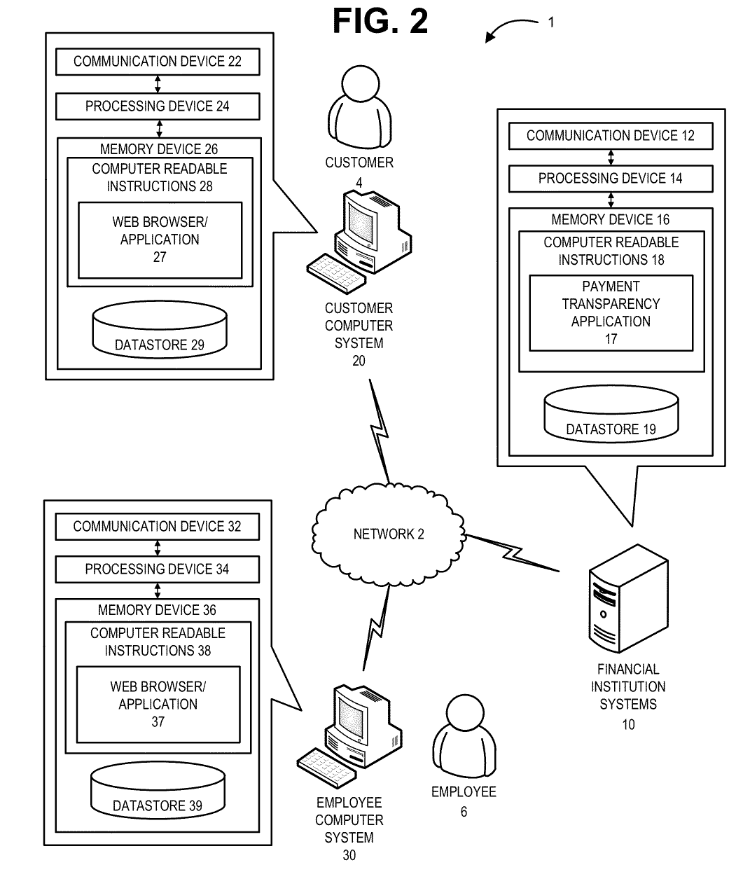

FIG. 2 illustrates a payment transparency tool system environment 1, in accordance with an embodiment of the present invention. As illustrated in FIG. 2, one or more financial institution systems 10 are operatively coupled, via a network 2, to customer computer systems 20, and employee computer systems 30. In this way one or more customers 4 or employees 6 may utilize the customer computer systems 20 or employee computer systems 30 to access the financial institution systems 10 to utilize the payment transparency application 17 (e.g., payment transparency tool) for viewing payment information related to the customer.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

In some embodiments of the invention the customers 4 (e.g., individual account holders, agents of an institutions that hold accounts, legal representatives or guardians of account holders, or the like) are the people that have one or more customer accounts with the financial institution. In some embodiments the employees 6 (e.g., associates, agents, consultants, contract workers, or others that work for or act on behalf of the financial institution, or the like) are the people that act on behalf of the institution during interactions with the customers 4.

As illustrated in FIG. 2, the financial institution systems 10 generally comprise a communication device 12, a processing device 14, and a memory device 16. The processing device 14 is operatively coupled to the communication device 12 and the memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 uses the communication device 12 to communicate with the network 2 and other devices on the network 2, such as, but not limited to, the customer computer systems 20 and the employee computer systems 30. As such, the communication device 12 generally comprises a modem, server, or other device for communicating with other devices on the network 2.

As further illustrated in FIG. 2, the financial institution systems 10 comprise computer-readable instructions 18 stored in the memory device 16, which in one embodiment includes the computer-readable instructions 18 of a payment transparency application 17 (e.g., mobile application, cloud application, system application, database application, or other like application). In some embodiments, the memory device 16 includes a datastore 19 for storing data related to the financial institution systems 10, including, but not limited to, data created and/or used by the payment transparency application 17. In other embodiments of the invention the payment transparency application 17 may be completely or partially located on the customer computer system 20 or employee computer system 30.

The payment transparency application 17 is a tool used to enables employees 6 and/or customers 4 to identify reasons that payments were assessed and the criteria for avoiding future payments. The payment transparency tool compiles and analyzes customer account information, identifies (e.g., determines) payment rules for particular types of accounts, identifies (e.g., determines) customized customer payment information for customer accounts, and provides the customer account information, payment rules, customized customer payment information to employees or customers to provide explanations and specialized dynamic data to address payment assessment questions, as is explained in further detail below.

As illustrated in FIG. 2, a customer 4 may access the payment transparency application 17 through a customer computer system 20. The customer computer system 20 may be a desktop, laptop, tablet, mobile device (e.g., smartphone device), or any other type of computer that generally comprises a communication device 22, a processing device 24, and a memory device 26. The processing device 24 is operatively coupled to the communication device 22, and the memory device 26. The processing device 24 uses the communication device 22 to communicate with the network 2 and other devices on the network 2, such as, but not limited to, the financial institution systems 10, the employee computer systems 30, and/or other systems. As such, the communication device 22 generally comprises a modem, server, or other device for communicating with other devices on the network 2 and/or a keypad, keyboard, touch-screen, touchpad, microphone, mouse, joystick, other pointer device, button, soft key, and/or other input device(s) for communicating with the customer 4.

As illustrated in FIG. 2, the customer computer systems 20 may have computer-readable instructions 28 stored in the memory device 26, which in one embodiment includes the computer-readable instructions 28 of a web browser or application 27 that allows the user 4 to access the payment transparency application 17, or receive information (e.g., payment information) from the payment transparency application 17 or the employee computer system 30. In some embodiments, the memory device 26 includes a datastore 29 for storing data related to the customer computer systems 20, including but not limited to data created and/or used by the web browser or application 27.

As illustrated in FIG. 2, the employee computer systems 30 generally comprise a communication device 32, a processing device 34, and a memory device 36. The processing device 34 is operatively coupled to the communication device 32 and the memory device 36. The processing device 34 uses the communication device 32 to communicate with the network 2 and other devices on the network 2, such as, but not limited to, the customer computer systems 20, the financial institution systems 10, and/or other systems. As such, the communication device 32 generally comprises a modem, server, or other device for communicating with other devices on the network 2 and/or a keypad, keyboard, touch-screen, touchpad, microphone, mouse, joystick, other pointer device, button, soft key, and/or other input device(s) for communicating with the employee 6.

As further illustrated in FIG. 2, the employee computer systems 30 comprise computer-readable instructions 38 stored in the memory device 36, which in one embodiment includes the computer-readable instructions 38 of a web browser or application 37 that allows an employee 6 to access the payment transparency application 17 or receive information (e.g., payment information) from the payment transparency application 17. In some embodiments, the memory device 36 includes a datastore 39 for storing data related to the employee computer systems 30, including but not limited to data created and/or used by the web browser or application 37.

As previously indicated in some embodiments of the invention the payment transparency tool 17 may be located completely or partially on the customer computer system 20 or employee computer system 30. As such, the customer 4 or employee 6 may only have to access the customer computer system 20 or the employee computer system 30 to access the payment transparency tool.

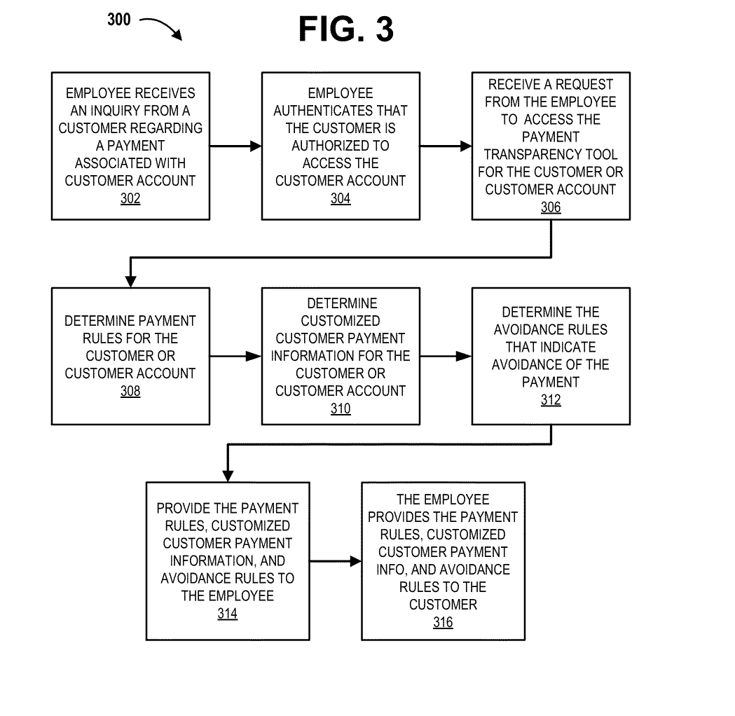

FIG. 3 illustrates an employee payment transparency method 300 in accordance with one embodiment of the invention. As illustrated by block 302, the employee 6 may receive an inquiry from a customer 4 regarding a payment associated with a customer account. In some embodiments the inquiry may occur in-person, over the telephone, or over a computer system (e.g., laptop, desktop, mobile device, or the like), or other like inquiry. In some embodiment of the inventions, the customer 6 may inquire from the employee 6 why the customer was assessed one or more payments on one or more customer accounts.

As illustrated in block 304 of FIG. 3, the employee authenticates that the customer 4 is authorized to access the customer account for which the payment inquiry is associated. In some embodiments of the invention the employee 6 authenticates the customer 4 manually or automatically over a computer system using a user ID and password, account number, pin number, security question, biometric identifier, or other like means of authentication.

Block 306 of FIG. 3 illustrates that the payment transparency tool receives a request from the employee 6 to access payment information for a customer or a customer account using the payment transparency tool. For example, the employee 6 may utilize a single customer account identifier (e.g., account number) for the customer 4, and as such, the payment transparency tool may access all of the customer accounts associated with the single customer account identifier (e.g., savings and investment accounts associated with a checking account). In other embodiments of the invention, the employee 6 may access one or more customer accounts for a customer 4 using a customer identifier (e.g., SSN, customer ID, or the like) of the customer 4, and as such the payment transparency tool may access all of the customer accounts associated with the customer 4. As such, the payment transparency tool receives an indication of the customer accounts for which the payment information is requested.

As illustrated by block 308 of FIG. 3 the payment transparency tool determines payment rules for the customer or the customer accounts. In some embodiments of the invention the payment rules are the general rules related to assessing payments from a particular type of account. In some embodiments of the invention the payment rules are set by the financial institution and indicate what events trigger the assessment or the removal of the assessment of payments on different types of customer accounts. The events may include, for example, customer average balance information (daily, weekly, or the like), direct deposit threshold (minimum, maximum, weekly, monthly, total yearly, or the like), customer type (retail, small business, medium business, large business, premium, or other like customer type), customer enrollment in a financial institution product (check image service, paperless statements, investment accounts, or the like), associated accounts of the customer (e.g., customer enrolled in multiple accounts). If the customer 4 meets one or more of these events then, in some embodiments, a payment may not be assessed against the customer account. However, if a customer fails to meet one or more of these events then a payment may be assessed on a customer account. As previously discussed the payments assessed for a particular customer account, or the events or the reasons that trigger an assessment may change over time, and thus, the payment transparency tool may access the current payment rules for each of the customer accounts as needed. As previously discussed, in some embodiments, the payment transparency tool may access different databases, or locations, where the information regarding the payment rules associated with customer accounts are stored. For example, the payment rules related to a checking account may be stored by the systems that store and assess payments from the checking account when the customer or customer account triggers an event that results in a payment (e.g., account balance is tool low). In other embodiments the payment rules for various customer accounts may be stored in a centralized location, such that the payment transparency tool accesses the various payment rules for multiple customer accounts in a single location. For example, the payment rules related to all customer accounts may be stored in central payment system that allows the systems that assess payments on customer account to determine if a customer account triggers an event that results in a payment.

As illustrated by block 310 in FIG. 3, the payment transparency tool determines customized customer payment information for the customer or the customer account. The customized customer payment information for the customer or customer account may include the specific customer or customer account information that resulted in a particular payment assessment on a customer account. In some embodiments of the invention the customized customer payment information may be the customer account information at the time that the particular payment assessed on the customer account occurred. In this way, in some embodiments of the invention every time a payment is assessed to a customer account, the customer account information related to the payment rules that resulted in the assessed payment is stored in case the information is needed in the future (e.g., to provide to the customer). For example, a customer 4 may inquire about a payment that was assessed a month in the past, and the payment transparency tool accesses the stored customer information or customer account information that resulted in the payment that occurred in the previous month. In other embodiments of the invention the customized customer payment information may include the customer account information at the time the customer makes an inquiry regarding a potential future payment, in order to provide information related to current potential payments or payments that may be assessed in the future. For example, the payment transparency tool may determine from the current customer or customer account information that the customer account will be assessed a payment unless the customer 4 makes one or more changes to one or more customer accounts. The customer or customer account information may be stored by the systems that are responsible for managing the transaction activity related to the various customer accounts. The payment transparency tool may access these systems to retrieve the customer account information as needed.

As illustrated by block 312 in FIG. 3, the payment transparency tool determines avoidance rules that indicate how the customer 4 can avoid assessed payments in the future. For example, the payment transparency tool may determine reason why a payment was assessed in the past or why a payment may be assessed in the future, and determine the one or more ways that the payment may be avoided by the customer 4 in the future. For example, the payment transparency tool may indicate that the customer should increase the average daily balance of checking account, increase the minimum amount of the direct deposits to the checking account, open investment accounts with the financial institution, or other like event. In some embodiments the avoidance rules may be same as or similar to the general payment rules. However, in other embodiments the avoidance rules may be more specifically tailored to a particular customer or customer account. As such, in some embodiments the avoidance rules may by customized and dynamically changed to illustrate how a specific customer may avoid payments based on changes in the customer's customer account information. The payment transparency tool may determine the avoidance rules by accessing different systems, databases, or locations, where the information regarding the payment rules associated with customer accounts are stored, and where the transaction activity related to the various customer accounts are stored.

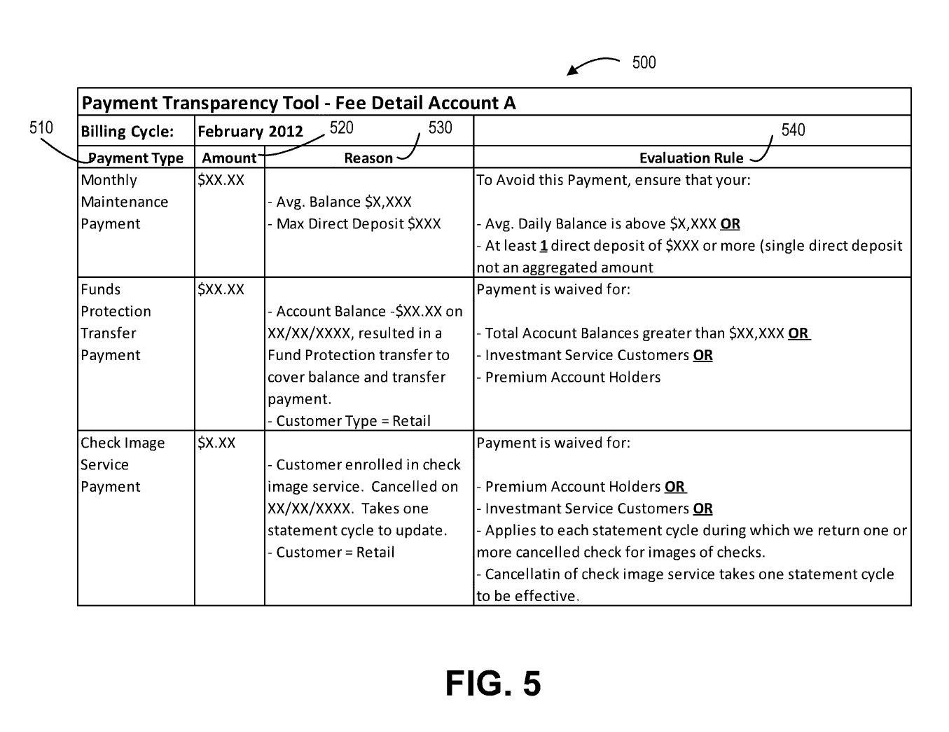

As illustrated by block 314 in FIG. 3, the payment transparency tool provides the payment rules, the customized customer payment information, and/or the avoidance rules for avoidance of the payment to the employee 6. For example, FIG. 5 illustrates an employee payment transparency interface 500 that may be presented to the employee 6 through an employee computer, employee mobile device, or other like employee computer system 30. In some embodiments, the employee payment transparency interface 500 provides a consolidated list of all of the payments assessed to one or more customer accounts of a customer 4 over a period of time. In other embodiments of the invention the employee payment transparency interface 500 provides a list of all of the payments assessed to a single customer account, and as such the employee 6 may select different customer accounts within the employee payment transparency interface 500, or different employee payment transparency interfaces 500, to view the payments associated with different customer accounts. The employee 6 may also select different time periods (e.g., billing periods) for which to view the payments assessed to one or more customer accounts.

In one embodiment of the invention the employee payment transparency interface 500 comprises a payment type section 510, a payment amount section 520, a payment reason section 530, and an evaluation rule section 540. The payment type section 510 illustrates the type of payment assessed to one or more customer accounts (e.g., monthly maintenance payment, funds protection transfer payment, check image service payment, or other like payment). In some embodiments of the invention the customer account associated with the payment and the payment date may also be provided in the payment type section 510 or another section of the employee payment transparency interface 500. The payment amount section 520 illustrates the amount of the payment assessed to the customer account. The payment reason section 530 illustrates the customized customer payment information for the customer or the customer account that does not meet the payment rules for a customer account. For example, the reason section 530 illustrates the specific average balance of customer account and the maximum direct deposit into the customer account which failed to meet the average balance requirements and direct deposit thresholds that would avoid the assessment of the payment. The evaluation rule section 540 illustrates the payment rule or avoidance rule that would avoid the assessment of the payment in the future. For example, as illustrated in FIG. 5, in order to avoid the assessed payment, the payment transparency tool may indicate that the customer 4 should have an average daily balance above a threshold level, or make at least one direct deposit greater than a minimum threshold value. In one embodiment the employee payment transparency interface 500 may be accessed by the customer 4 to allow the customer 4 to review one or more payments assessed on one or more consolidated lists within the payment transparency interface 500.

As illustrated by block 316 the employee 6 provides the payment rules, customized customer payment information, and/or the avoidance rules to the customer 4. For example, the employee 6 may provide this information in a face-to-face interaction, over a teleconference, over the computer through e-mail, a computer interface, or other like communication means.

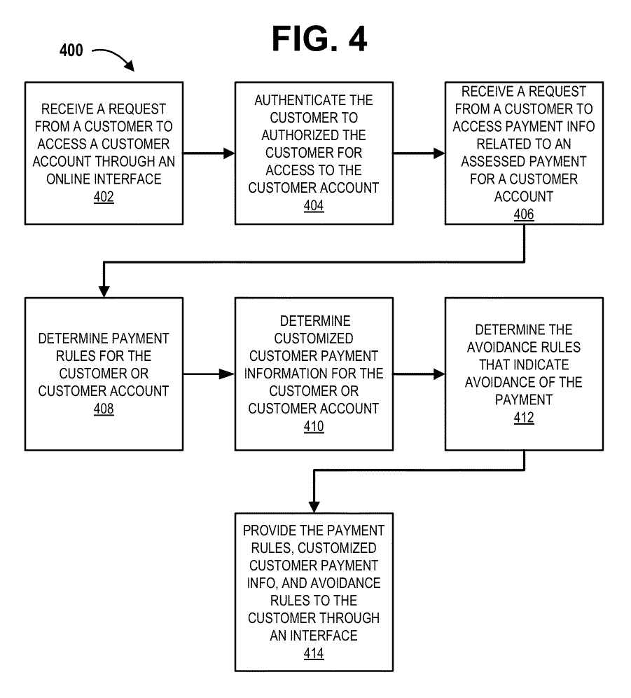

FIG. 4 illustrates a customer payment transparency method 400, in accordance with one embodiment of the invention. As illustrated by block 402, the financial institution receives a request from a customer 4 to access a customer account through an online interface. Thereafter, the financial institution authenticates the customer 4 in order to determine if the customer 4 has access to the customer account, as illustrated by block 404. In some embodiments of the invention the financial institution authenticates the customer 4 using a user ID and password, account number, pin number, security question, biometric information, or other like means of authentication.

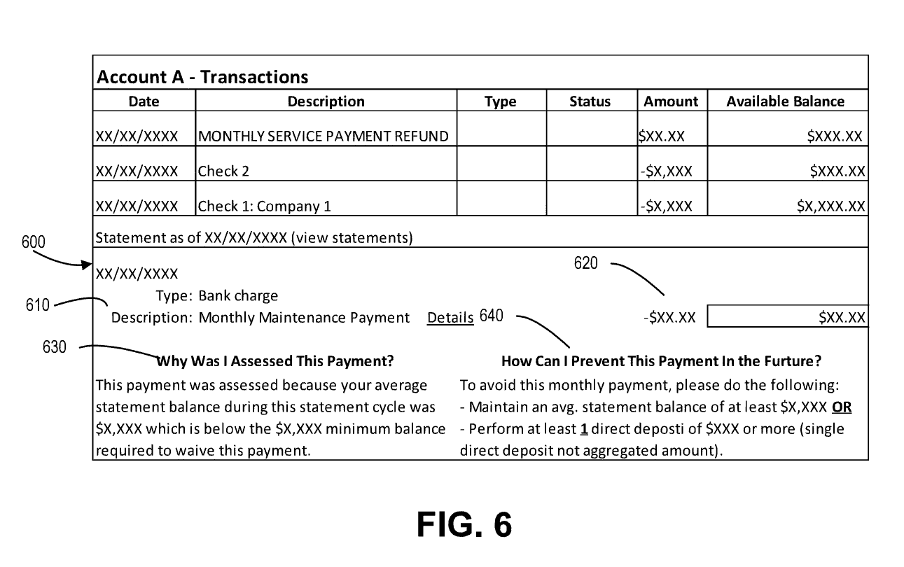

Block 406 of FIG. 4 illustrates that the payment transparency tool receives a request from the customer 4 to access payment information for a customer or a customer account. For example, the customer may access a payment transparency tool directly to view the assessed payment on one or more of the customer accounts in a consolidated interface. In other embodiments of the invention, the customer 4 may be viewing an account summary interface that illustrates a list of transactions for a customer account, including transactions for payments assessed on the account, and the customer 4 may request additional information about a payment listed in the account summary interface. An example of this types of interface is illustrated in FIG. 6, and is discussed in further detail below.

Block 408 of FIG. 4, illustrates that the payment transparency tool determines payment rules for the customer or customer account. The payment rules are determined in the same way as previously discussed with respect to block 308 of FIG. 3.

As illustrated by block 410 of FIG. 4, the payment transparency tool determines customized customer payment information for the customer or customer account. The customized customer payment information is determined in the same way as previously discussed with respect to block 310 of FIG. 3.

Block 412 of FIG. 4 illustrates that the payment transparency tool determines avoidance rules that indicate how the assessed payment or a potential future payment may be avoided in the future. The avoidance rules are determined in the same way as previously discussed with respect to block 312 of FIG. 3.

As illustrated by block 414 the payment transparency tool provides the payment rules, customized customer payment information, and avoidance rules to the customer 4 through an interface, such as a customer account interface.

For example, in one embodiment of the invention, the customer payment transparency interface 600 illustrated in FIG. 6 is an online banking account interface provided to a customer 4 through a customer computer, customer mobile device, or other like customer computer system 20. The customer payment transparency interface 600 may be displayed to the customer in response to the customer 4 making an inquiry for additional information associated with a payment assessed to a customer account, using a drop down arrow, link, selection button, or other like feature in an interface. As illustrated in FIG. 6 after making the inquiry for additional payment information a customer 4 may be provided the payment transparency interface 600. The payment transparency interface may display a payment type section 610, payment amount section 620, customized payment section 630, and a payment avoidance section 640. As previously discussed with respect to FIG. 5 the payment type section 610 indicates the type of payment assessed to a customer account (e.g., description, date, payment name, or the like), the payment amount section illustrates the amount of the payment assessed to the customer account. The customized payment section 630 illustrates the specific reasons the customer was assessed the payment. For example, as illustrated in FIG. 6, the customized payment section may illustrate the customer 4 was assessed a payment because the average customer balance during the statement cycle was below a threshold value needed to waive the payment. The avoidance section 640 illustrates the payment rules or avoidance rules that would avoid the assessment of the payment in the future. For example, as illustrated in FIG. 6, to avoid the assessed payment, the payment transparency tool may indicate that the customer 4 should have an average daily balance above a threshold level, or make at least one direct deposit greater than a minimum threshold value.

In some embodiments of the invention the avoidance section 640 may provide customized avoidance information regarding what the customer should do to avoid the payment in the future. In some embodiments the avoidance section 640 may include links to take actions with respect to customer accounts to avoid the assessment of payments (e.g., current payments or future payments). For example, the avoidance section 640 may provide a link to the customer to open a specific account, may indicate that the customer should transfer a specific amount of money from one account to another and provide a link to make the transfer, provide details on how a customer can become a platinum customer, provide details that if a customer links the customer's accounts together (e.g., linked two credit card accounts and a checking account together) payments on the accounts may be avoided, or provide other like information that may prevent payments on one or more customer accounts.

In other embodiments of the invention, the payment transparency tool may provide alerts to a customer 4 or an employee 6 to notify them of potential, impending, or posted payments. In one embodiment, the payment transparency tool determines when a payment may be assessed on a customer account in the future (e.g., impending or potential payment), and alerts the customer 4 or an employee 6. The payment transparency tool may determine if a payment is going to be assessed from the payment rules and the customized customer payment information for one or more customer accounts. The payment transparency tool may alert the customer 4 or employee 6 by sending an e-mail, text message, pop-up notification in an interface, highlight a potential payment in a list of future transactions in an interface (e.g., employee payment transaction interface, customer payment transaction interface), or provides another like notification.

In still other embodiments of the invention the payment transparency tool may be able to provide an alert to a customer 4 or an employee 6 when an action the customer 4 or an employee 6 is taking is will result in a potential payment in the future. For example, if a customer 4 or an employee 6 is closing a customer account, changing a direct deposit, transferring funds from one account to another account, adding or removing a service for an account (e.g., enrolled in check image service, or the like), a notification may be sent, or an indicator may be activated, to alert the customer 4 or employee 6 of a potential payment.

In still other embodiments of an invention, a payment may have been waived in the past due to actions that the customer 4 or the financial institution made in the past. An alert may be provided to the customer 4 or an employee 6 when the wavier of the payment is going to expire or be removed by a policy change. The payment transparency tool may also prompt an action from the customer 4 or an employee 6 to extend a waiver of a payment if the customer 4 takes an action on the customer account or a related account. For example, a customer 4 may have signed up for free wealth management advice for six months, and the six month free trial period may be set to expire. The payment transparency tool may provide an alert to the customer 4 that the free trial period is about to end, and the customer 4 may be assessed a payment in the next billing cycle if the customer 4 does not take an action. As such, the payment transparency tool may indicate that the customer 4 may be able to extend the waiver of the wealth management payment if the customer has investable assets that meet a threshold level.

In some embodiments of the invention the payment transparency tool may track historic payment information related to when payments have been typically assessed on customer accounts over periods of time, and thereafter provide alerts to a customer 4 or employee 6 for potential future payments and avoidance of potential future payments. For example, a customer 4 may have received a payment for maintaining a low average balance in December in four out of the last five years, and as a result the payment transparency tool may provide an alert to the customer to remind the customer 4 to keep the average balance above a threshold level or provide other ways to avoid the potential payment.

In still other embodiments of the invention the payment transparency tool may track payments that could have been assessed against the customer in the past, but were not assessed as a result of the customer meeting particular payment rules. As such, the payment transparency tool may provide a summary of the payments that the customer has avoided in the past based on the customer's activities related to the customer's account. For example, the payment transparency tool may alert the customer 4 that a checking account payment has been waived fifteen times because the customer 4 has kept the average balance above the threshold valve for fifteen months. Alternatively, the payment transparency tool may provide a report to the customer 4 that illustrates the historical payments that could have been avoided if the customer had taken specified actions with respect to the customer's accounts. For example, the payment transparency tool may provide an alert or notification that the customer 4 could have avoided payments assessed on a checking account for the last ten months if the customer had taken advantage of a minimum directed deposit amount (e.g., used direct deposit instead of manual deposit for the customer's paycheck).

In some embodiments of the invention, the payment transparency tool may track that a customer acknowledged an alert of a potential payment or an alert on how to avoid a payment. For example, when an alert is provided to a customer 2, such as through an e-mail the payment transparency tool may be able to track when the e-mail is opened by the customer 4. In another example when an indication of a potential payment is provided to a customer 4 in an interface (e.g., pop-up notification) the customer 4 may be required to acknowledge (e.g., select an “ok” or “yes” feature) the potential payment before the customer 4 may be able to proceed with other actions in the interface. In this way if a customer 4 tries to dispute a payment, the financial institution may be able to identify that the customer 4 previously acknowledged the payment, indicated awareness of the payment, and/or accepted the payment.

In one embodiment of the invention the payment transparency tool may provide a customer payment status view to the customer 4 or the employee 6 that illustrates all of the payments that are avoided by the customer 4 in light of the status of all of the customer's accounts. In this way the payment transparency tool may access all of the payments that are not assessed to the customer's accounts, but would have or could have been if the customer had not taken specific actions with respect to the accounts.

In other embodiments of the invention the payment transparency tool may include an indicator selection (e.g., one-click button, link, or other like feature) that allows a customer 4 to seek further assistance from an employee 6 (e.g., financial institution associate). The indicator selection, in some embodiments, opens a help ticket that is escalated to an employee 6 to further research a payment. In other embodiments the indicator selection opens up a communication channel (e.g., message chat, telephone conversation, e-mail inquiry, or other like channel) to discuss a payment with an employee 6. The customer 4 may utilize the indicator selection to receive help related to a payment, to dispute a payment, or for other like purposes.

In some embodiments of the invention, the payment transparency tool may keep track of the number of times a customer 4 or employee 6 utilizes the payment transparency tool, as well as the number of times the use of the tool resulted in payment avoidance. For example, the customer 4 may have accessed the tool ten times in the last month and taken actions using links in the tool, or other actions outside of the tool, that prevented a payment from being assessed against a customer account. For example, out of the ten times the customer 4 used the tool the customer opened a new account once, transferred money into another account twice, and increased a direct deposit amount once, and thus prevented payments on four of the ten uses of the payment transparency tool.

The interfaces are not limited to the interfaces discussed herein. Different types of interfaces may be utilized to provide payment rules, customized customer payment information, or avoidance rules to the customer 4 for one or more payments for one or more customer accounts, in various embodiments of the invention. In some embodiments the potential future payments may also be included in the interfaces (e.g., in the consolidated payment assessment list).

The customer 4 may be able to opt in or out of the various features of the payment transparency tool including, but not limited to, receiving alerts related to payments assessed or potential payments assessed on one or more the customer accounts.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A system comprising:
a memory device having computer readable program code store thereon; and
a processing device operatively coupled to the memory device, wherein the processing device is configured to execute the computer readable program code to:
receive an inquiry regarding a payment assessed to a customer account of a customer at a financial institution;
access customer account information for the customer account of the customer;
determine payment rule information for the customer account based on the customer account information;
determine customized customer payment information that resulted in the payment; and
provide the payment rule information and the customized customer payment information to a user.

2. The system of claim 1, wherein the user is an employee of the financial institution and the payment rule information and customized customer payment information is provided to the employee over an employee payment transparency interface.

3. The system of claim 1, wherein the user is the customer of the financial institution and the payment rule information and customized customer payment information is provided to the customer over a customer payment transparency interface, wherein the customer payment transparency interface is an online banking account interface.

4. The system of claim 1, wherein the processing device is further configured to execute the computer readable program code to:
determine avoidance rules that would avoid the payment assessed in the future; and
provide the avoidance rules to the user.

5. The system of claim 1, wherein the processing device is further configured to execute the computer readable program code to:
provide a consolidated payment assessment list in a centralized payment transparency interface, wherein the consolidated payment assessment list provides the payment rule information and the customized customer payment information to a user for two or more payments for two or more customer accounts.

6. The system of claim 5, wherein the processing device is further configured to execute the computer readable program code to:
receive a time period selection indicating a time period for the consolidated payment assessment list; and
provide the payment rule information and the customized customer payment information in the consolidated payment assessment list for the two or more payments for two or more customer accounts to the user for the time period.

7. The system of claim 5, wherein processing device is further configured to execute the computer readable program code to:
receive a customer accounts selection indicating the two or more customer accounts to include in the consolidated payment assessment list; and
provide the payment rule information and the customized customer payment information in the consolidated payment assessment list for the two or more customer accounts selected.

8. A computer program product, the computer program product comprising at least one non-transitory computer-readable medium having computer-readable program code portions embodied therein, the computer-readable program code portions comprising:
an executable portion configured to receive an inquiry regarding a payment assessed to a customer account of a customer at a financial institution;
an executable portion configured to access customer account information for the customer account of the customer;
an executable portion configured to determine payment rule information for the customer account based on the customer account information;
an executable portion configured to determine customized customer payment information that resulted in the payment; and
an executable portion configured to provide the payment rule information and the customized customer payment information to a user.

9. The computer program product of claim 8, wherein the user is an employee of the financial institution and the payment rule information and customized customer payment information is provided to the employee over an employee payment transparency interface.

10. The computer program product of claim 8, wherein the user is the customer of the financial institution and the payment rule information and customized customer payment information is provided to the customer over a customer payment transparency interface, wherein the customer payment transparency interface is an online banking account interface.

11. The computer program product of claim 8, wherein the computer-readable program code portions further comprise:
an executable portion configured to determine avoidance rules that would avoid the payment assessed in the future; and
an executable portion configured to provide the avoidance rules to the user.

12. The computer program product of claim 8, wherein the computer-readable program code portions further comprise:
an executable portion configured to provide a consolidated payment assessment list in a centralized payment transparency interface, wherein the consolidated payment assessment list provides the payment rule information and the customized customer payment information to a user for two or more payments for two or more customer accounts.

13. The computer program product of claim 12, wherein the computer-readable program code portions further comprise:
an executable portion configured to receive a time period selection indicating a time period for the consolidated payment assessment list; and
an executable portion configured to provide the payment rule information and the customized customer payment information in the consolidated payment assessment list for the two or more payments for two or more customer accounts to the user for the time period.

14. The computer program product of claim 12, wherein the computer-readable program code portions further comprise:
an executable portion configured to receive a customer accounts selection indicating the two or more customer accounts to include in the consolidated payment assessment list; and
an executable portion configured to provide the payment rule information and the customized customer payment information in the consolidated payment assessment list for the two or more customer accounts selected.

15. A method comprising:
receiving an inquiry regarding a payment assessed to a customer account of a customer at a financial institution;
accessing, by a processing device, customer account information for the customer account of the customer;
determining, by the processing device, payment rule information for the customer account based on the customer account information;
determining, by the processing device, customized customer payment information that resulted in the payment; and
providing the payment rule information and the customized customer payment information to a user.

16. The method of claim 15, wherein the user is an employee of the financial institution and the payment rule information and customized customer payment information is provided to the employee over an employee payment transparency interface.

17. The method of claim 15, wherein the user is the customer of the financial institution and the payment rule information and customized customer payment information is provided to the customer over a customer payment transparency interface, wherein the customer payment transparency interface is an online banking account interface.

18. The method of claim 15, further comprising:
determining, by the processing device, avoidance rules that would avoid the payment assessed in the future; and
providing the avoidance rules to the user.

19. The method of claim 15, further comprising:
providing, by the processing device, a consolidated payment assessment list in a centralized payment transparency interface, wherein the consolidated payment assessment list provides the payment rule information and the customized customer payment information to a user for two or more payments for two or more customer accounts.

20. The method of claim 19, further comprising:
receiving a time period selection indicating a time period for the consolidated payment assessment list; and
providing, by the processing device, the payment rule information and the customized customer payment information in the consolidated payment assessment list for the two or more payments for two or more customer accounts to the user for the time period.

21. The method of claim 19, further comprising:
receiving a customer accounts selection indicating the two or more customer accounts to include in the consolidated payment assessment list; and
providing, by the processing device, the payment rule information and the customized customer payment information in the consolidated payment assessment list for the two or more customer accounts selected.
